(19) United States
(12) Patent Application Publication
(10) Pub. No.: US 2011/0036613 A1
(43) Pub. Date: Feb. 17, 2011

(54) ELECTRONIC WIRE AND METHOD OF MANUFACTURING THE SAME

(75) Inventors: Tatsunori Hayashishita, Hachinohe-shi (JP); Hirokazu Takahashi, Satsuki-cho (JP)

Correspondence Address: GLOBAL IP COUNSELORS, LLP, 1233 20TH STREET, NW, SUITE 700, WASHINGTON, DC, 20036-2680, US

(73) Assignee: SUMITOMO ELECTRIC INDUSTRIES, LTD., Osaka-shi, Osaka (JP)

(21) Appl. No.: 12/990,249

(22) PCT Filed: Apr. 23, 2010
(86) PCT No.: PCT/JP2010/057253

§ 371 Date: Oct. 29, 2010

(30) Foreign Application Priority Data
Apr. 24, 2009 (JP) 2009-106907
Apr. 24, 2009 (JP) 2009-106908

(51) Int. Cl. H01B 7/18; H01B 7/02; H01B 13/14

(52) U.S. Cl. 174/105 R; 174/110 SR; 174/107; 427/117; 29/868

(57) ABSTRACT

To provide an electronic wire having a diameter reduced while ensuring an excellent abrasion resistance and a method of manufacturing the electronic wire.

An electronic wire 1 is obtained by coaxially providing sequentially a central conductor 2, an insulator 4, an outer conductor 6 and a jacket 7. The central conductor 2 consists of twisted copper alloy wires 3 each containing silver in an amount which is equal to or larger than 1 weight % and is equal to or smaller than 3 weight % and each having a diameter which is equal to or larger than 0.010 mm and is equal to or smaller than 0.025 mm, and a tensile strength of the central conductor is equal to or higher than 950 MPa and a conductivity of the central conductor is equal to or higher than 70% IACS and is equal to or lower than 85% IACS. The jacket 7 is formed of ETFE having a melt flow rate which is equal to or higher than 25 and is equal to or lower than 45, and has a thickness which is equal to or greater than 10 μm and is equal to or smaller than 30 μm, and has an outside diameter which is equal to or smaller than 0.35 mm.

### TECHNICAL FIELD

The present invention relates to an electronic wire and a method of manufacturing the same.

### BACKGROUND ART

There are known an insulated wire and a coaxial wire which have jackets formed of ETFE (an ethylene-tetra-fluorinated ethylene copolymer resin). For instance, there is known an electronic wire obtained by spirally winding a first porous PTFE tape having a thickness of 0.13 mm×a width of 0.8 mm and a porosity of 75% at a pitch of 3.0 mm around a central conductor having a continuous sinusoidal waviness with a pitch of 3.0 mm and a waviness height of 0.65 mm formed on an AWG (American Wire Gauge) #28 silver-plated copper wire and further winding a second porous PTFE tape having a thickness of 0.13 mm×a width of 2 mm and a porosity of 75% spirally thereover at a pitch of 5.5 mm in a reverse winding direction to a winding direction of the first tape to form a porous tape wound insulating layer, and forming, on a periphery thereof, a transverse winding shield including forty tin-plated copper wires having an outside diameter of 0.06 mm as an outer conductor, and furthermore, extruding the ETFE to the periphery to form a coating layer (for example, see Patent Document 1).

Moreover, there is described that a resin such as ETFE can be used as a resin of a coating layer in an extra fine insulated wire having a conductor core wire and a coating layer obtained by extruding a resin around the conductor core wire to carry out coating (for example, see Patent Document 2).

Furthermore, there is known a coaxial wire obtained by twisting a plurality of copper alloy wires containing 1 to 3 weight % of silver and copper and an unavoidable impurity in a residual part and having a diameter of 0.010 to 0.025 mm to form a copper alloy twisted wire, coating a periphery of the copper alloy twisted wire having a tensile strength of 850 MPa or more and a conductivity of 85% IACS or more with a solid insulator having a thickness of 0.07 mm or less, spirally winding a plurality of conductor wires around the periphery of the insulator in a longitudinal direction to form an outer conductor, and coating a surface of the outer conductor with a jacket layer (for example, see Patent Document 3).

### PRIOR ART DOCUMENT

### Patent Document

Patent Document 1: Japanese Laid-Open Patent Publication: JP-A-9-259657 Publication

Patent Document 2: Japanese Laid-Open Patent Publication: JP-A-2004-56302 Publication

Patent Document 3: Japanese Laid-Open Patent Publication JP-A-2007-172928 Publication

### SUMMARY OF THE INVENTION

### Problems that the Invention is to Solve

In an electronic apparatus such as a portable terminal, a small-sized video camera or a medical apparatus in order to further reduce a size and a thickness of the apparatus, it is desirable to further decrease a diameter of an electronic wire which serves to electrically connect casings or components to be relatively moved and is bent, twisted or slid, and it is possible to propose a reduction in a thickness of a jacket of the electronic wire.

By using a very thin fluororesin (PFA) as a resin of the jacket, it is possible to decrease the diameter of the electronic wire by reducing the thickness of the jacket to be equal to or smaller than 30 μm, for example. If the thickness is equal to or smaller than 30 μm, however, an abrasion resistance of the jacket is deteriorated. If the abrasion resistance of the jacket is deteriorated, there is a possibility that a drawback might be caused, for example, the jacket might be broken in handling in an assembling work or due to mounting on an accommodating space.

The Patent Documents 1 and 2 disclose that ETFE is used as a resin material of a jacket of an electronic wire. However, it is hard to form a thin ETFE jacket by carrying out extrusion coating on a general molding condition.

An object of the present invention is to provide an electronic wire having a diameter reduced while ensuring an excellent abrasion resistance and a method of manufacturing the electronic wire.

### Means for Solving the Problems

An electronic wire of the invention which can solve the above problems is an electronic wire in which a periphery of a conductor is coated with a resin,

wherein a resin forming an outermost layer is consisting of ETFE having a melt flow rate which is equal to or higher than 25 and is equal to or lower than 45, and the outermost layer has a thickness which is equal to or greater than 10 μm and is equal to or smaller than 30 μm.

In the electronic wire of the invention, it is preferable that the electronic wire is a coaxial wire in which an insulator, an outer conductor and a jacket are coaxially provided sequentially around a central conductor, the central conductor consists of twisted copper alloy wires each containing silver in an amount which is equal to or larger than 1 weight % and is equal to or smaller than 3 weight % and each having a diameter which is equal to or larger than 0.010 mm and is equal to or smaller than 0.025 mm, and a tensile strength of the central conductor is equal to or higher than 950 MPa and a conductivity of the central conductor is equal to or higher than 70% IACS and is equal to or lower than 85% IACS, and the jacket serves as an outermost layer and has an outside diameter which is equal to or smaller than 0.45 mm.

Further, it is preferable that the jacket has an outside diameter which is equal to or smaller than 0.35 mm.

In the electronic wire of the invention, it is preferable that the insulator which is adjacent to a peripheral side of the central conductor is formed of PFA.

A multicore cable of the invention is obtained by bundling a plurality of electronic wires of the invention.

A method of manufacturing an electronic wire of the invention is a method of manufacturing an electronic wire in which a periphery of a conductor is coated with a resin, comprising:

carrying out extrusion coating with ETFE having a melt flow rate which is equal to or higher than 25 and is equal to or lower than 45 at a draw-down ratio set to be equal to or higher than 250 to form an outermost layer having a thickness which is equal to or greater than 10 μm and is equal to or smaller than 30 μm.

In the method of manufacturing an electronic wire of the invention, it is preferable that it comprises:

forming a central conductor by twisting a copper alloy wire containing silver in an amount which is equal to or larger than 1 weight % and is equal to or smaller than 3 weight % and having a diameter which is equal to or larger than 0.010 mm and is equal to or smaller than 0.025 mm;

coating a periphery of the central conductor with an insulator;

winding an outer conductor around a periphery of the insulator; and

further coating a periphery of the outer conductor with a jacket to be the outermost layer so that an outside diameter is set to be equal to or smaller than 0.45 mm.

Further, it is preferable that the jacket has an outside diameter which is equal to or smaller than 0.35 mm.

### ADVANTAGE OF THE INVENTION

According to the electronic wire in accordance with the invention, the outermost layer is formed of the ETFE. Therefore, it is possible to ensure a high abrasion resistance. In addition, the melt flow rate of the resin forming the outermost layer is set to be equal to or higher than 25 and to be equal to or lower than 45 and the thickness of the outermost layer is set to be equal to or greater than 10 μm and to be equal to or smaller than 30 μm. Therefore, it is also possible to reduce a diameter. Consequently, it is possible to well use the electronic wire as an electronic wire to be accommodated in a small accommodating space in order to electrically connect casings which are relatively moved through rotation, pivoting or sliding.

According to the method of manufacturing an electronic wire in accordance with the invention, furthermore, it is possible to smoothly manufacture an electronic wire having a diameter reduced while ensuring an excellent abrasion resistance.

### BRIEF DESCRIPTION OF THE DRAWINGS

FIG. 1 shows an example of an embodiment of an electronic wire according to the invention and is a perspective view showing an end of the wire at which each member of the electronic wire is exposed stepwise.

FIG. 2 is a sectional view showing the electronic wire of FIG. 1.

FIG. 3 is a sectional view showing a state in which a jacket of the electronic wire is subjected to an extrusion molding.

FIG. 4 is a view showing a state of a bending test method.

### BEST MODE FOR CARRYING OUT THE INVENTION

An example of an embodiment of an electronic wire and a method of manufacturing the same according to the invention will be described below with reference to the drawings.

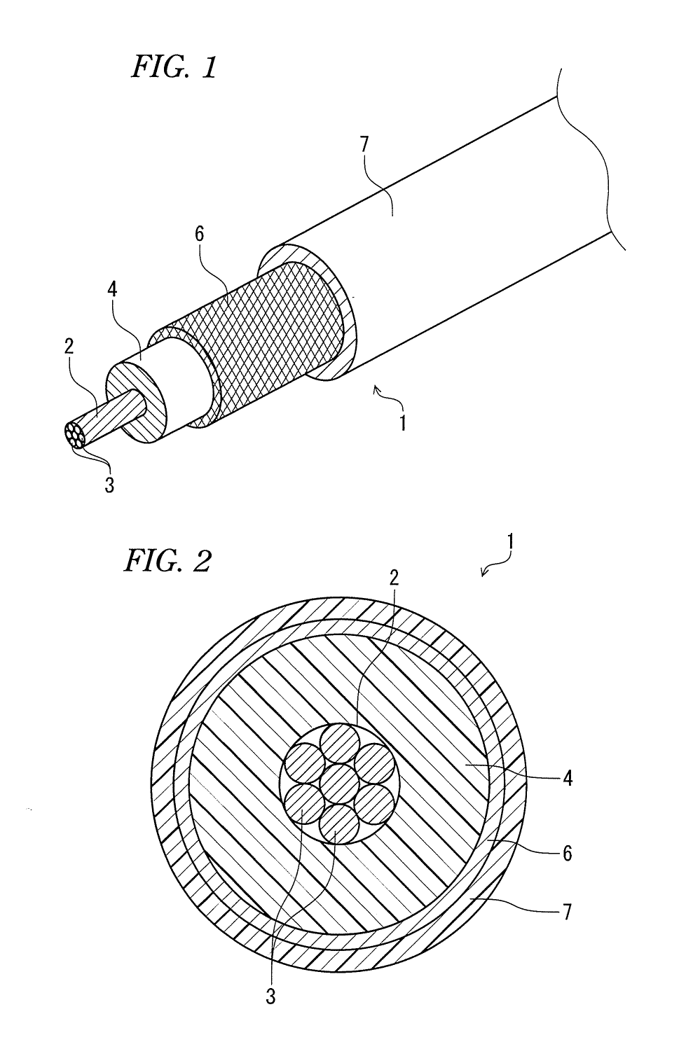

FIG. 1 is a perspective view showing an end of the cable at which each member of the electronic wire is exposed stepwise and FIG. 2 is a sectional view showing the electronic wire.

As shown in FIGS. 1 and 2, an electronic wire 1 is a coaxial wire having a central conductor 2 and an outer conductor 6.

In the electronic wire 1, the central conductor 2 is disposed on a center, an insulator 4 is formed around the central conductor 2, and furthermore, the outer conductor 6 is disposed around the insulator 4. The outer conductor 6 is coated with a jacket 7.

The central conductor 2 is constituted by using a plurality of wires formed by a conductive metal and having a small diameter. In the embodiment, there is used the central conductor 2 obtained by utilizing seven copper alloy wires 3 having very small diameters and twisting six copper alloy wires 3 around a single copper alloy wire 3.

The copper alloy wire 3 is formed by a copper alloy containing silver in an amount which is equal to or larger than 0.1 weight % and is equal to or smaller than 3 weight %, and is set to have a diameter which is equal to or larger than 0.010 mm and is equal to or smaller than 0.025 mm. The copper alloy wire 3 has a surface on which a tin, silver or nickel plated layer is formed.

The insulator 4 is formed of PFA (a tetrafluoroethylene-perfluoroalkylvinyl ether copolymer) to be a fluorine based resin and has an outside diameter set to be approximately 0.07 to 0.20 mm.

The outer conductor 6 is formed through braiding or spirally winding by using a plurality of wires constituted by a conductive metal and having a small diameter (for example, a tin-plated copper alloy wire) and is provided for coating over a periphery of the insulator 4.

The outer conductor 6 may be formed by wrapping longitudinally or spirally winding a metallic tape around the periphery of the insulator 4, for example.

In case of the spirally winding or the braiding, a copper wire or a copper alloy wire (a tin and copper alloy) is used as a wire, and the wire has a size (a diameter) of 0.01 to 0.04 mm.

In the case in which the metallic tape (which is obtained by applying a metal foil to a resin tape such as PET) is used, the resin tape has a thickness of approximately 2 to 10 μm and a metal layer (copper or aluminum) has a thickness of 0.1 to 3 μm.

ETFE (an ethylene-tetrafluoroethylene copolymer) an example of a fluorine based resin is used as a resin serving as the jacket 7 forming an outermost layer of the electronic wire 1. The jacket 7 has a thickness set to be equal to or greater than 10 μm and to be equal to or smaller than 30 μm and has an outside diameter set to be equal to or smaller than 0.45 mm. A more preferable outside diameter of the jacket 7 is equal to or smaller than 0.35 mm.

The resin of the jacket 7 has a melt flow rate (MFR: Melt Flow Rate) which is equal to or higher than 25 (g/10 minutes) and is equal to or lower than 45 (g/10 minutes) (at a temperature of 297 (C, a load of 5 kg).

Since the MFR of the resin forming the jacket 7 to be the outermost layer is equal to or higher than 25 and is equal to or lower than 45, the jacket 7 with a small thickness can be formed by carrying out extrusion molding.

Furthermore, the electronic wire 1 according to the embodiment has an outside diameter which is equal to or smaller than 0.45 mm (is preferably equal to or smaller than 0.35 mm), and the insulator 4 which is adjacent to the peripheral side of the central conductor 2 is formed of the PFA. Therefore, it is possible to obtain an electronic wire having a low dielectric constant of an insulator, and a very small diameter and a low capacity. In the case in which the insulator is formed of the PFA and the jacket is formed of the ETFE, moreover, the insulator (PFA) has a higher melting point and is prevented from being thermally damaged when the jacket is subjected to extrusion coating, which is preferable.

In the case in which a terminal processing is carried out to connect the electronic wire 1, the jacket 7 of the electronic wire 1 is first cut in a position placed apart from an end at a predetermined distance and the end side is pulled out and removed.

Then, the outer conductor 6 is cut in a position which is close to an end by a predetermined length from the position in which the jacket 7 is cut, and the outer conductor 6 on the end side is pulled out and removed.

Thereafter, the insulator 4 is further cut in a position which is close to an end, and the insulator 4 on the end side is pulled out and removed.

In the case in which the end of the jacket is removed in the terminal processing, a slit is formed on the jacket by a CO² laser and the end of the jacket is then pulled and extracted, for example. The slit is not formed over the whole periphery and the end of the jacket is pulled and thus torn in a part in which the slit is not formed. At this time, there is caused a drawback that the torn portion of the jacket is deformed, rolled up or damaged in some cases in which the jacket is formed of the PFA.

According to the electronic wire 1 in accordance with the embodiment, however, the jacket 7 to be the outermost layer is formed of the ETFE. Therefore, it is possible to ensure an excellent abrasion resistance. In addition, the thickness of the jacket 7 to be the outermost layer is set to be equal to or greater than 10 μm and to be equal to or smaller than 30 μm. Therefore, it is also possible to reduce the diameter to be equal to or smaller than 0.45 mm (to be preferably equal to or smaller than 0.35 mm). Consequently, it is possible to well use the electronic wire as an electronic wire to be accommodated in a small accommodating space through rotation, pivoting or sliding.

In general, the central conductor of the coaxial wire has a tendency that a conductivity and a tensile strength are usually incompatible with each other. When the tensile strength is raised, the conductivity is reduced so that a transmission loss is increased.

In the electronic wire 1, if the central conductor 2 is set to be a twisted wire obtained by twisting the copper alloy wire 3 having a silver concentration which is equal to or higher than 0.1 weight % and is equal to or lower than 1 weight %, the tensile strength is equal to or higher than 600 MPa and the conductivity is equal to or higher than 85% IACS. If the central conductor 2 is set to be a twisted wire obtained by twisting a copper alloy wire containing silver in an amount which is equal to or larger than 1 weight % and is equal to or smaller than 3 weight % and having a diameter which is equal to or larger than 0.010 mm and is equal to or smaller than 0.025 mm, the tensile strength is equal to or higher than 950 MPa and the conductivity is equal to or higher than 70% IACS and is equal to or lower than 85% IACS.

For the case in which a bending resistance of the electronic wire 1 is enhanced, it is preferable to set the silver concentration of the central conductor to be equal to or higher than 1 weight % and to be equal to or lower than 3 weight %. By a combination of the central conductor 2 and the jacket 7, it is possible to obtain the electronic wire 1 having a diameter reduced while ensuring an excellent bending property. Accordingly, it is possible to well use the electronic wire as an electronic wire which is accommodated in a small accommodating space in order to electrically connect casings to be relatively moved through rotation, pivoting or sliding and is excellent in a transmitting performance.

There is a tendency that a Joule heat generated in the central conductor 2 in a signal transmission is increased and a transmission loss thus becomes remarkable if the conductivity of the central conductor 2 of the electronic wire 1 is lower than 70% IACS. By twisting the copper alloy wire 3 containing silver in an amount which is equal to or smaller than 3 weight % and having a diameter which is equal to or larger than 0.010 mm and is equal to or smaller than 0.025 mm, however, it is possible to achieve a high conductivity of 70% IACS or more and a high tensile strength in the central conductor 2 simultaneously and reliably.

The electronic wire 1 having the structure described above is used in an electronic apparatus such as a portable terminal, a small-sized video camera or a medical apparatus, and is also used as an electronic wire which electrically connects casings to be relatively moved through rotation, pivoting or sliding and is bent, twisted or slid. Since the electronic wire 1 is excellent in the bending resistance, it is suitable for the uses.

On the other hand, in the case in which the conductivity is to be enhanced, it is preferable to set the silver concentration of the central conductor to be equal to or higher than 0.1 weight % and to be equal to or lower than 1 weight %. For example, in the case in which the central conductor is constituted by using a copper alloy wire containing 0.6 weight % of silver, the conductivity of the central conductor is approximately 90% IACS. The tensile strength of the central conductor can be ensured to be approximately 700 to 800 MPa.

Next, description will be given to a method of manufacturing the electronic wire 1.

First of all, seven copper alloy wires 3 formed by a copper alloy containing silver in an amount which is equal to or larger than 0.1 weight % and is equal to or smaller than 3 weight % (preferably 2 weight %) and having a very small diameter are twisted to form the central conductor 2. In the case in which a silver and copper alloy having a silver concentration of 0.6 weight % is used as the copper alloy wire 3, for example, the central conductor 2 is set to have a tensile strength which is equal to or higher than 600 MPa and a conductivity which is equal to or higher than 85% IACS. In the case in which the silver concentration is set to be 2 weight %, the central conductor 2 has a tensile strength which is equal to or higher than 950 MPa and a conductivity which is equal to or higher than 70% IACS and is equal to or lower than 80% IACS. The periphery of the central conductor 2 is extrusion coated with PFA serving as the insulator 4.

The insulator 4 may be constituted by winding a fluororesin tape such as PTFE (polytetrafluoroethylene).

For example, seven conductors (silver and copper alloy wires) containing 0.1 to 1 weight % of silver and having a diameter of 0.025 mm are twisted to form the central conductor 2 having a diameter of 0.075 mm. A foamed PTFE (polytetrafluoroethylene) tape having a thickness of 0.050 mm is spirally wound therearound. A PET (polyethylene terephthalate) tape having a thickness of 0.004 mm is spirally wound therearound. A dimension of the conductor or a thickness of the insulator may be reduced to decrease a diameter more greatly.

Next, a plurality of wires having small diameters and consisting of a conductive metal is braided or spirally wound around the periphery of the insulator 4 to provide the outer conductor 6.

Then, the periphery of the outer conductor 6 is extrusion coated with ETFE serving as the jacket 7 and having MFR which is equal to or higher than 25 and is equal to or lower than 45, and the jacket 7 having a thickness which is equal to or greater than 10 μm and is equal to or smaller than 30 μm is thus formed. Consequently, there is obtained the electronic wire 1 having an outside diameter which is equal to or smaller than 0.45 mm (is preferably equal to or smaller than 0.35 mm).

A resin tape such as PET may be wound as tape wrapping around the periphery of the outer conductor 6 to form the jacket 7.

In order to carry out extrusion coating with the ETFE, thereby forming the jacket 7 on the outermost layer of the electronic wire 1, a die and a point which are to be used for extrusion molding are selected to set a draw-down ratio to be a molding condition which is equal to or higher than 250 and is equal to or lower than 1000.

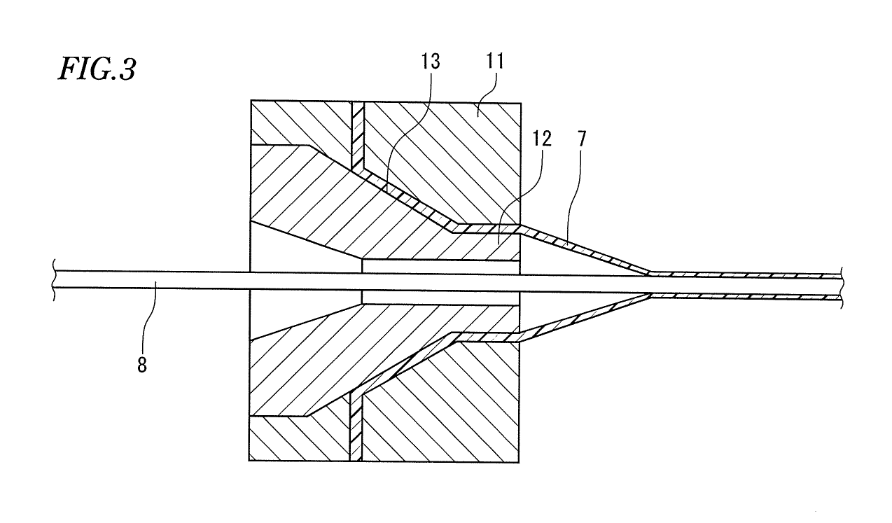

FIG. 3 shows a state in which the jacket is subjected to the extrusion molding through the draw-down.

An ETFE resin is supplied to a resin passage 13 between a die 11 and a point 12. A center of the point 12 is set to be a through hole and causes an electronic wire (a non-coated core) 8 having an outer conductor to pass therethrough. The resin 7 extruded from an outlet between the die 11 and the point 12 does not immediately come in contact with the non-coated core (the outer conductor) 8 but is gradually thinned, and comes in contact with the non-coated core 8 to carry out coating on a point placed apart from the outlet.

The draw-down ratio can be calculated in accordance with (an inside diameter of a die)²−(an outside diameter of a point)²/(a finished diameter of an electronic wire)²−(a diameter of a non-coated core)². In the case in which the ETFE is used for the coating of the electronic wire, the draw-down ratio is usually 50 to 100. In the embodiment, the draw-down ratio was set to have a great value which is equal to or higher than 250 differently from the conventional art. Thus, a thin ETFE jacket was implemented successfully. By using ETFE having a melt flow rate (MFR) which is equal to or higher than 25 (g/10 minutes) and is equal to or lower than 45 (g/10 minutes) (at a temperature of 297 (C, a load of 5 kg), it was possible to set the draw-down ratio into the range.

Consequently, the jacket 7 having a thickness which is equal to or greater than 10 μm and is equal to or smaller than 30 μm can be formed around the periphery of the outer conductor 6.

In the case in which the finished diameter of the electronic wire is set to be 0.35 mm and the thickness of the jacket is set to be 0.03 mm, the die and the point are combined for use in such a manner that a difference between the square of the inside diameter of the die and that of the outside diameter of the point is 30.4 mm². The combination is carried out in such a manner that an end of the point and that of the die are on a level with each other.

An ETFE resin having MFR which is equal to or higher than 25 and is equal to or lower than 45 (for example, 30) is supplied to the resin passage 13 between the die 11 and the point 12 which are thus combined with each other.

According to the method of manufacturing an electronic wire, it is possible to smoothly manufacture the electronic wire 1 which has a diameter reduced with a high abrasion resistance ensured and prevents a drawback in a terminal processing or an increase in a transmission loss from being caused.

The electronic wire 1 is also used as a multicore cable obtained by bundling a plurality of wires. For example, a multicore cable obtained by arranging 20 to 50 coaxial wires in a line to take a flat shape and connecting them to a connector is used in a portable telephone. In the multicore cable, both ends take flat shapes and an intermediate part is bundled to be round in some cases. The multicore cable is connected to FPC (a flexible board) or PWB (a printed wiring board) in place of the connector in some cases. Alternatively, a plurality of wires is collected and is wrapped with a tape or coated with a tube to form a unit, and a plurality of units is further collected to form a multicore cable coated with a jacket. The multicore cable is used in a medical apparatus. In some cases, a coaxial wire in the unit or the unit is twisted. In some cases, a shield layer for shielding a plurality of units in a lump is provided on an inside of the jacket of the multicore cable.

Although the description has been given by taking, as an example, the electronic wire 1 formed by the coaxial wire having the structure in which the central conductor 2, the insulator 4, the outer conductor 6 and the jacket 7 are coaxially provided sequentially in the embodiment, the invention is not restricted to the coaxial wire but an electronic wire having a periphery coated with a resin can also be applied to an insulated wire in which a periphery of a conductor is coated with a jacket.

For example, it is also possible to employ an insulated wire obtained by twisting seven wires constituted by a tin-plated copper alloy and having a diameter of 0.016 mm to form a conductor having a diameter of 0.05 mm and extrusion coating a periphery with ETFE to form a jacket having a thickness of 30 μm, and setting an outside diameter to be 0.11 mm.

It is also possible to set a jacket to have a two-layer structure and to constitute an inner layer by winding a fluororesin tape such as PTFE (polytetrafluoroethylene) or to carry out extrusion coating with another resin such as PFA. By using the PFA for an inner layer of an insulator, it is possible to reduce a dielectric constant of the insulator. By using the ETFE for an outer layer, it is possible to enhance a abrasion resistance of the insulator (which also serves as a jacket in this case).

### EXAMPLE

### First Example

Central conductor: Twist seven copper alloy wires containing 2 weight % of silver and having a diameter of 0.016 mm

Diameter of central conductor: 0.048 mm

Insulator: PFA

Thickness of insulator: 0.035 mm

Diameter of insulator: 0.118 mm

Outer conductor: Spirally wind a tin-plated tin and copper alloy having a wire diameter of 0.025 mm

Diameter of outer conductor portion of electronic wire: 0.168 mm

Jacket: ETFE

Thickness of jacket: 0.025 mm

Diameter of jacket: 0.220 mm

### Second Example

The same electronic wire as that in the first example except that a silver concentration of a central conductor is set to be 0.6 weight %

### Comparative Example

The same electronic wire as that in the second example except that PFA is used for a jacket

The number of failures to be external damages caused on an electronic wire in mounting of the electronic wire on 100 sets of products was three in a comparative example in which a jacket 7 was formed of PFA, while it was zero in the first and second examples in which the jacket 7 was formed of the ETFE.

It can be supposed that the ETFE has a tensile break strength which is approximately 1.3 times as great as that of the PFA and an elongation which is approximately 1.2 times as high as that of the PFA, and is damaged with difficulty in a terminal processing. As in the example, according to the electronic wire 1 in which the jacket 7 is formed of the ETFE, it is possible to prevent a drawback that the jacket 7 is broken in handling in an assembling work or mounting on a accommodating space.

Next, there were measured amounts of attenuation in the first example (the central conductor containing 2 weight % of silver and formed by a silver and copper alloy) and the second example (the central conductor containing 0.6 weight % of silver and formed by a silver and copper alloy). The amount of attenuation was 7.5 dB/m at 500 MHz in the first example and the amounts of attenuation were equal to each other, that is, 7.2 dB/m at 500 MHz in the second example and the comparative example.

A bending test was carried out for the coaxial wires according to the examples and the comparative example.

### (1) Bending Test Method

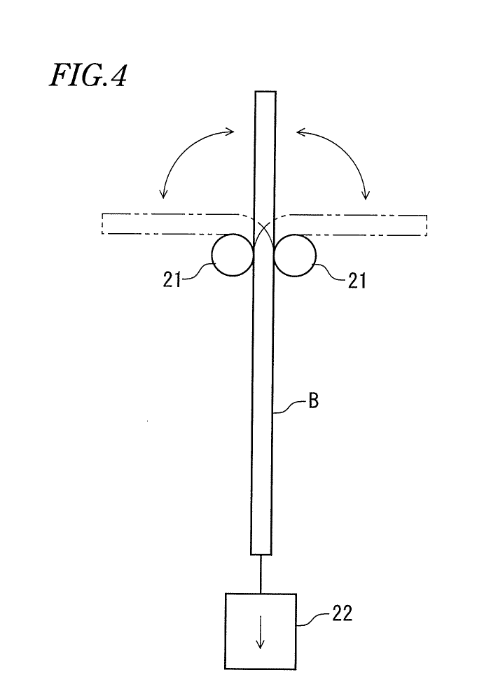

As shown in FIG. 4, a bundle B obtained by spirally winding a PTFE tape around 40 coaxial wires was inserted between a pair of mandrels 21 and a weight 22 was attached to a lower end of the bundle B, and an upper end of the bundle B was gripped and the bundle B was bent to left and right in abutment on the mandrel 21 side to check a presence of a disconnection of the coaxial wire. The coaxial wires were bundled without an alignment and the PTFE tape was fixed with an adhesive tape at both ends of the bundle B.

### (2) Test Condition

(2-1)
Bending angle: ±90 degrees
Speed: 30 (number of reciprocations/minute)
Mandrel diameter: 6 mm
Load applied by weight: 1.96 (N) (200 (gf))
(2-2)
Bending angle: ±90 degrees
Speed: 30 (number of reciprocations/minute)
Mandrel diameter: 2 mm
Load applied by weight: 2 (N)

### (3) Result of Test

### (3-1) Result of Bending Test on Test Condition (2-1)

The bending test was carried out for three specimens to make an evaluation in the first example, the second example and the comparative example.

In the first example, the second example and the comparative example, there was no disconnection in 100000 bending operations. In the first example, the coaxial wire was not disconnected also in 300000 bending operations. On the other hand, in the comparative example, any of coaxial wires bundled at one hundred and several ten thousand times was disconnected.

### (3-2) Result of Bending Test on Test Condition (2-2)

The bending test was carried out for three specimens to make an evaluation in the first example, the second example and the comparative example. In the first example, the coaxial wire was disconnected in average 70000 bending operations. In the second example, the coaxial wire was disconnected in average 37000 bending operations. On the other hand, in the comparative example, the coaxial wire was disconnected in average 26000 bending operations. As a result, it was apparent that a bending resistance is more excellent in the examples than that in the comparative example.

In the first example, it can be supposed that the bending resistance was enhanced by the fact that the copper alloy wires containing the silver in an amount which is equal to or larger than 1 weight % and is equal to or smaller than 3 weight % and having a diameter which is equal to or larger than 0.010 mm and is equal to or smaller than 0.025 mm were twisted to form the central conductor and a tensile break strength thereof was set to be equal to or higher than 950 MPa, and the jacket was formed of the ETFE in place of the PFA. In the second example, it can be supposed that the bending resistance was enhanced by the fact that the jacket was formed of the ETFE in place of the PFA. While the elongation of the PFA is 340 to 400%, that of the ETFE is approximately 1.2 times as high as that of the PFA, that is, 400 to 450%.

Although the invention has been described in detail with reference to the specific embodiment, it is apparent to the skilled in the art that various changes and modifications can be made without departing from the spirit and scope of the invention. The application is based on Japanese Patent Application (Japanese Patent Application No. 2009-106907) filed on Apr. 24, 2009 and Japanese Patent Application (Japanese Patent Application No. 2009-106908) filed on Apr. 24, 2009 and contents thereof are incorporated herein by reference.

### EXPLANATION OF DESIGNATION

1: electronic wire, 2: central conductor, 4: insulator, 6: outer conductor, 7: jacket

1. An electronic wire in which a periphery of a conductor is coated with a resin,
wherein a resin forming an outermost layer is consisting of ETFE having a melt flow rate which is equal to or higher than 25 and is equal to or lower than 45, and the outermost layer has a thickness which is equal to or greater than 10 μm and is equal to or smaller than 30 μm.

2. The electronic wire according to claim 1, wherein the electronic wire is a coaxial wire in which an insulator, an outer conductor and a jacket are coaxially provided sequentially around a central conductor,
the central conductor consists of twisted copper alloy wires each containing silver in an amount which is equal to or larger than 1 weight % and is equal to or smaller than 3 weight % and each having a diameter which is equal to or larger than 0.010 mm and is equal to or smaller than 0.025 mm, and a tensile strength of the central conductor is equal to or higher than 950 MPa and a conductivity of the central conductor is equal to or higher than 70% IACS and is equal to or lower than 85% IACS, and
the jacket serves as an outermost layer and has an outside diameter which is equal to or smaller than 0.45 mm.

3. The electronic wire according to claim 2, wherein the jacket has an outside diameter which is equal to or smaller than 0.35 mm.

4. The electronic wire according to claim 2, wherein the insulator which is adjacent to a peripheral side of the central conductor is formed of PFA.

5. A multicore cable obtained by bundling a plurality of electronic wires according to claim 2.

6. A method of manufacturing an electronic wire in which a periphery of a conductor is coated with a resin, comprising:
carrying out extrusion coating with ETFE having a melt flow rate which is equal to or higher than 25 and is equal to or lower than 45 at a draw-down ratio set to be equal to or higher than 250 to form an outermost layer having a thickness which is equal to or greater than 10 μm and is equal to or smaller than 30 μm.

7. The method of manufacturing an electronic wire according to claim 6, comprising:
forming a central conductor by twisting a copper alloy wire containing silver in an amount which is equal to or larger than 1 weight % and is equal to or smaller than 3 weight % and having a diameter which is equal to or larger than 0.010 mm and is equal to or smaller than 0.025 mm;
coating a periphery of the central conductor with an insulator;
winding an outer conductor around a periphery of the insulator; and
further coating a periphery of the outer conductor with a jacket to be the outermost layer so that an outside diameter is set to be equal to or smaller than 0.45 mm.

8. The electronic wire according to claim 3, wherein the insulator which is adjacent to a peripheral side of the central conductor is formed of PFA.

9. A multicore cable obtained by bundling a plurality of electronic wires according to claim 3.
